(19) United States
(12) Patent Application Publication
(10) Pub. No.: US 2005/0126793 A1
(43) Pub. Date: Jun. 16, 2005

(54) Horseshoe and shoeing method

(76) Inventors: Dustin McCuan, Long Branch, NJ (US); Matthew Spoerlein, Long Branch, NJ (US)

Correspondence Address: Martin Novack, 16355 Vintage Oaks Lane, Delray Beach, FL, 33484, US

(21) Appl. No.: 10/973,661

(22) Filed: Oct. 25, 2004

Related U.S. Application Data
(60) Provisional application No. 60/514,493, filed on Oct. 24, 2003.

(51) Int. Cl. A01L 3/00

(52) U.S. Cl. 168/17

(57) ABSTRACT

A nail-free horseshoe for application to a horse's hoof, which includes: a U-shaped shoe body having a rounded toe end, a pair of opposing heel ends, and a pair of intermediate curved quarter regions between the toe end and the heel ends; the body having a ground-engaging lower surface and a generally flat hoof-engaging upper surface adapted for engagement with the bottom of the hoof; and a pair of spaced apart flexible malleable metal pads extending upwardly from the outer peripheries of the respective quarter regions; whereby an adhesive can be applied between the hoof, the upper surface of the body, and the inner surfaces of the pads, the horseshoe can be applied to the hoof, and the flexible malleable pads can be bent to conform to the sides of the hoof.

### RELATED APPLICATION

Priority is claimed from U.S. Provisional Patent Application No. 60/514,493, filed Oct. 24, 2003, and said Provisional Application is incorporated herein by reference.

### FIELD OF THE INVENTION

This invention relates to equine shoeing and, more particularly, to an improved horseshoe and to an improved method of shoeing a horse.

### BACKGROUND OF THE INVENTION

Shoes have been applied to the hooves of horses for hundreds of years. Traditionally, the shoes have been formed of metal, such as steel, and provided with nail holes, and nails have been used to secure each shoe to a hoof by hammering the nails through the nail holes and into the hoof.

In modern times, various alternative shoe materials and methods of attachment have been developed. For example, for horses that race (such as thoroughbreds or standardbreds), lightweight shoes can be formed of materials such as aluminum, titanium, or alloys. Attachment of shoes using an adhesive (e.g. a glue or epoxy) has become an alternative shoeing technique, but, for various reasons, some of which are discussed hereinbelow, the technique is used for only a small percentage of shoeings, with nailing still predominating.

The hoof is a growing part of a horse's body and, also, horseshoes tend to wear out and/or loosen. For these and other reasons, horses must be periodically reshod. For example, a racehorse may be reshod approximately once a month. Nailing, while still the prevalent method of attachment, has some obvious disadvantages in that the nail holes can stress, weaken, or damage the hoof, especially after repeated shoeings. Use of adhesives has had limited success because of several drawbacks. Typically, a glue or epoxy is applied between the top surface of the shoe and the bottom of the hoof, and it is not sufficiently resilient or strong to withstand the enormous and uneven forces that are encountered as the horse gallops at high speed. Also, when shoes are changed, the presence of built-up adhesive residue can be problematic.

A number of techniques have been proposed which involve partial attachment of the horseshoe to the sides of the hoof. Reference can be made, for example, to U.S. Pat. Nos. 4,819,731, 5,638,905, and 5,692,569. These types of approaches have had drawbacks and limitations, however, including one or more of the following: complexity, high cost, impracticality for shoeing, and/or lack of durability. It is among the objects of the present invention to provide an improved horseshoe and shoeing method which does not have the drawbacks and limitations of prior approaches.

It is also among the objects of the present invention to provide an improved horseshoe and shoeing method that addresses and solves the problem of shoeing horses that have contracted (i.e., contracted and/or collapsed) heels. The condition, which can be caused by genetic disposition or by injury, can be understood by referring to FIGS. 1 and 2. FIG. 1 shows a normal hoof 110 with heel 111, toe 112, quarter 115, and a properly proportioned z/pastern 117, which subtends an angle z with respect to the bottom of the hoof. FIG. 2 shows a hoof with a contracted heel 211, a toe 212, and quarter 215. In this illustration, the heel is seen to be underslung, and the pastern 217 is elongated, a characteristic of this condition, along with an angle z that is more acute than in the normal hoof of FIG. 1. As stated, it is among the objects hereof to provide a shoe and shoeing method that addresses and solves this problem.

### SUMMARY OF THE INVENTION

A form of the invention is directed to a nail-free horseshoe for application to a horse's hoof, which comprises: a U-shaped shoe body having a rounded toe end, a pair of opposing heel ends, and a pair of intermediate curved quarter regions between the toe end and the heel ends; said body having a ground-engaging lower surface and a generally flat hoof-engaging upper surface adapted for engagement with the bottom of the hoof; and a pair of spaced apart flexible malleable metal pads extending upwardly from the outer peripheries of the respective quarter regions; whereby an adhesive can be applied between the hoof, the upper surface of said body, and the inner surfaces of the pads, the horseshoe can be applied to the hoof, and the flexible malleable pads can be bent to conform to the sides of the hoof.

In an embodiment of the invention, the pads preferably have an inner surface area of at least 1 square inch, and, more preferably, an inner surface area of at least 4 square inches. In this embodiment, each of the pads has at least one aperture.

Another form of the invention is directed to a method for shoeing a horse having a contracted heel, including the following steps: providing a horseshoe comprising a U-shaped shoe body having a rounded toe end, a pair of opposing heel ends, and a pair of intermediate curved quarter regions between the toe end and the heel ends; said body having a ground-engaging lower surface and a generally flat hoof-engaging upper surface adapted for engagement with the bottom of the hoof; and a pair of spaced apart flexible malleable metal pads extending upwardly from the outer peripheries of the respective quarter regions, each of the pads having at least one aperture; applying an adhesive between the hoof, the upper surface of said body, and the inner surfaces of the pads, applying a spacer between the forward portion of the bottom of the hoof and the top surface of the shoe body, and applying the horseshoe to said the hoof at an angle with respect to the bottom of the hoof; and bending said pads to conform to the sides of the hoof.

Further features and advantages of the invention will become more readily apparent from the following detailed description when taken in conjunction with the accompanying drawings.

### BRIEF DESCRIPTION OF THE DRAWINGS

FIG. 1 illustrates a normal equine hoof.

FIG. 2 illustrates an equine hoof having a condition known as a contracted heel.

FIG. 3 is a top view of a horseshoe in accordance in an embodiment of the invention.

FIG. 4 is a side view of the FIG. 3 embodiment.

FIG. 5 illustrates the horseshoe of the embodiment of FIGS. 3, 4 on a hoof.

FIG. 6 illustrates a side view of a prior art horseshoe with standard “clips”.

FIG. 7 is a side view of a horseshoe in accordance with a further embodiment of the invention, which can be used for treating a contracted heel condition.

FIG. 8 shows the embodiment of FIG. 7, as applied a hoof having a contracted heel condition.

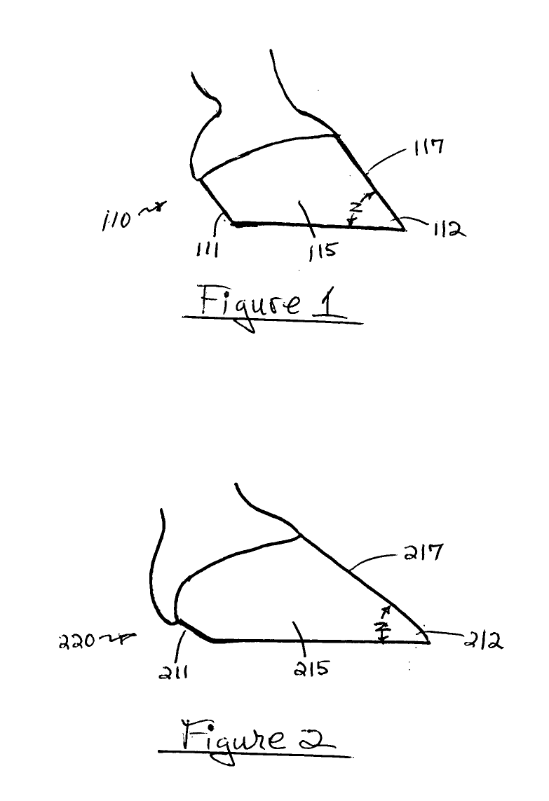

### DETAILED DESCRIPTION

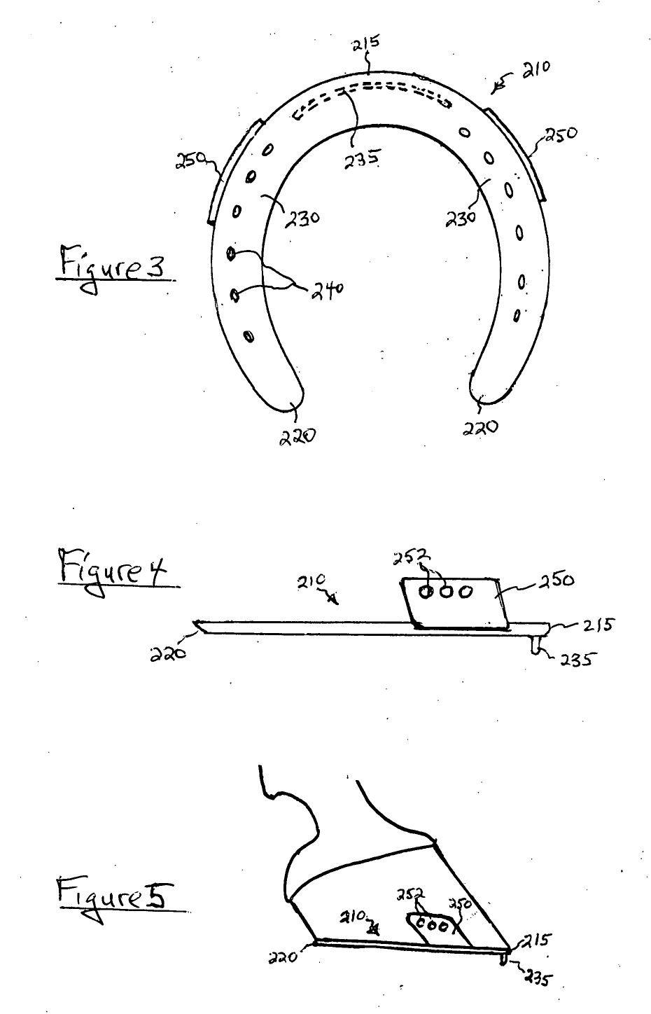

FIGS. 3, 4, and 5 illustrate a horseshoe in accordance with an embodiment of the invention. A U-shaped shoe body is similar to a conventional shoe in that it includes a rounded toe end 215, a pair of opposing heel ends 220, and intermediate quarter regions 230, as well as a bottom toe grab 235 and nail holes 240. In accordance with a feature of the invention, flexible malleable metal pads 250 extend upwardly from the outer peripheries of the respective quarter regions 230. The pads 250 can be applied to the shoe body by any suitable secure method, for example, welding. They may also be integrally manufactured with the shoe body. In the present embodiment, each pad 250 is formed of aluminum or an aluminum alloy. The metal is sufficiently thin, flexible, and malleable to be conformed, by bending (e.g. by pounding with a hammer) to the sides of a horse's hoof when the horse is shod. The adhesive is applied, for example, to the insides of the pads 250, and the toe region of the shoe, the shoe is applied to the hoof, and the pads 250 are compressed (pressed and/or pounded) to conform to the shape of the hoof. The adhesive may be, for example, “Equilox” epoxy, which is commonly used for applying horseshoes. One of the advantages of the invention is that adhesive need not be applied at the heel, so the hoof has freedom of expansion of its lateral cartilage.

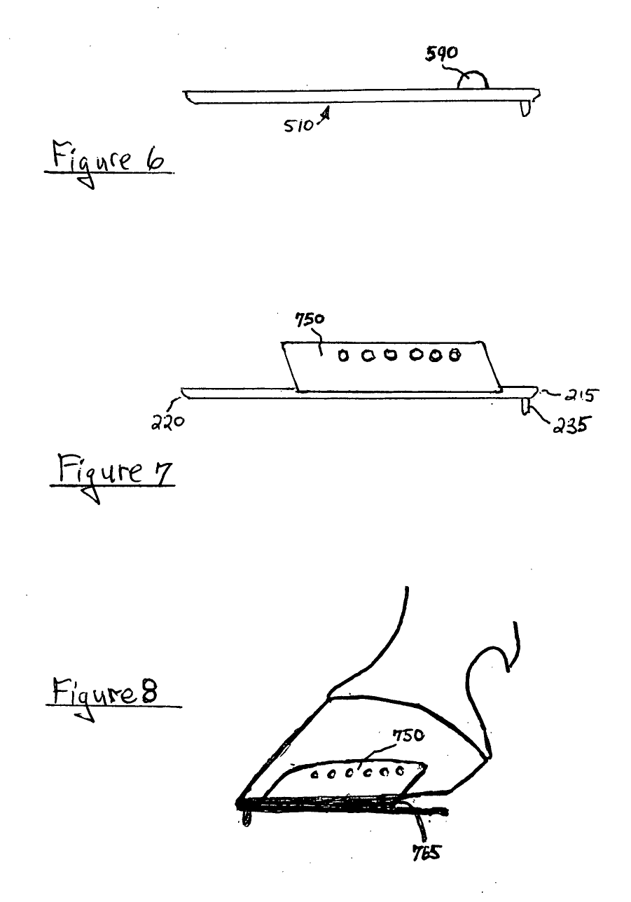

For comparison, FIG. 6 illustrates a prior art horseshoe which has standard “clips”, one of which is illustrated at 590. The pads 250 of the invention have a much larger area than standard clips 590, which are rigid and are conventionally provided on horseshoes (that are to be nailed on, or otherwise) to help keep a shoe in place. In the present embodiment, the pads 250, after application to the shoe, have an exposed inner surface area of at least 1 square inch. Each pad has at least one and, preferably a plurality, of apertures 252 through which adhesive can flow out to overlap on the outside of the pad. This also occurs at the peripheral edges of the pad 250, which can be beveled. The aperture area(s) preferably total at least 0.25 square inch. However, too great an open area could compromise structural integrity.

A further embodiment of the invention, used for shoeing a horse with a contracted heel deformity, is shown in FIG. 7. This horseshoe employs a more elongated pad 750, preferably at least 3 inches long, and, more preferably in the range 4 to 5 inches long, and with a height in the range 1 to 2 inches, to provide more gripping area, preferably at least 4 square inches on the inner surface of the pad 750. FIG. 8 shows how the horseshoe of the FIG. 7 embodiment can be applied to a hoof having a contracted heel condition. In this case, adhesive is applied at the toe region and the pads 750, and a rubber pad 765 is used between the hoof and shoe at the toe and quarter regions, and removed at the heels. Accordingly, the heel end of the shoe surface is spaced from the heel bottom of the hoof. This restores the pastern angle, z, as seen in FIG. 8, and also realigns the boney column.

1. A nail-free horseshoe for application to a horse's hoof comprising:
a U-shaped shoe body having a rounded toe end, a pair of opposing heel ends, and a pair of intermediate curved quarter regions between said toe end and said heel ends;
said body having a ground-engaging lower surface and a generally flat hoof-engaging upper surface adapted for engagement with the bottom of the hoof; and
a pair of spaced apart flexible malleable metal pads extending upwardly from the outer peripheries of said respective quarter regions;
whereby an adhesive can be applied between the hoof, the upper surface of said body, and the inner surfaces of said pads, said horseshoe can be applied to said hoof, and said flexible malleable pads can be bent to conform to the sides of the hoof.

2. The horseshoe as defined by claim 1, wherein said pads have an inner surface area of at least 1 square inch.

3. The horseshoe as defined by claim 1, wherein said pads have an inner surface area of at least 4 square inches.

4. The horseshoe as defined by claim 1, wherein each of said pads has a height of at least 1 inch above the upper surface of said shoe body.

5. The horseshoe as defined by claim 1, wherein each of said pads has a lateral extent of at least 1 inch.

6. The horseshoe as defined by claim 4, wherein each of said pads has a lateral extent of at least 1 inch.

7. The horseshoe as defined by claim 1, wherein each of said pads has a lateral extent of at least 3 inches.

8. The horseshoe as defined by claim 4, wherein each of said pads has a lateral extent of at least 3 inches.

9. The horseshoe as defined by claim 1, wherein each of said pads has at least one aperture.

10. The horseshoe as defined by claim 2, wherein each of said pads has at least one aperture.

11. The horseshoe as defined by claim 4, wherein each of said pads has at least one aperture.

12. The method as defined by claim 1, wherein each of said pads has a plurality of apertures.

13. The method as defined by claim 3, wherein each of said pads has a plurality of apertures.

14. The method as defined by claim 8, wherein each of said pads has a plurality of apertures.

15. The horseshoe as defined by claim 1, wherein said pads are formed of aluminum.

16. The horseshoe as defined by claim 2, wherein said pads are formed of aluminum.

17. The horseshoe as defined by claim 3, wherein said pads are formed of aluminum.

18. A method for shoeing a horse, comprising the steps of:
providing a horseshoe comprising a U-shaped shoe body having a rounded toe end, a pair of opposing heel ends, and a pair of intermediate curved quarter regions between said toe end and said heel ends; said body having a ground-engaging lower surface and a generally flat hoof-engaging upper surface adapted for engagement with the bottom of the hoof; and a pair of spaced apart flexible malleable metal pads extending upwardly from the outer peripheries of said respective quarter regions, each of pads having at least one aperture;
applying an adhesive between the hoof, the upper surface of said body, and the inner surfaces of said pads, and applying said horseshoe to said hoof; and
bending said pads to conform to the sides of the hoof.

19. A method for shoeing a horse having a contracted heel, comprising the steps of:
providing a horseshoe comprising a U-shaped shoe body having a rounded toe end, a pair of opposing heel ends, and a pair of intermediate curved quarter regions between said toe end and said heel ends; said body having a ground-engaging lower surface and a generally flat hoof-engaging upper surface adapted for engagement with the bottom of the hoof; and a pair of spaced apart flexible malleable metal pads extending upwardly from the outer peripheries of said respective quarter regions, each of said pads having at least one aperture;
applying an adhesive between the hoof, the upper surface of said body, and the inner surfaces of said pads, applying a spacer between the forward portion of the bottom of the hoof and the top surface of the shoe body, and applying said horseshoe to said hoof at an angle with respect to the bottom of said hoof; and
bending said pads to conform to the sides of the hoof.
